(19) United States
(12) Patent Application Publication
(10) Pub. No.: US 2025/0274676 A1
(43) Pub. Date: Aug. 28, 2025

(54) IMAGE CAPTURING SYSTEM CAPABLE OF PERFORMING IMAGE CAPTURING IN DESIRED CHARGE ACCUMULATION TIME IN IMAGE SENSOR WHILE SUPPRESSING GENERATION OF STRIPES, IMAGE CAPTURING APPARATUS, LIGHTING DEVICE, METHOD OF CONTROLLING IMAGE CAPTURING SYSTEM, AND STORAGE MEDIUM

(71) Applicant: CANON KABUSHIKI KAISHA, Tokyo (JP)

(72) Inventor: YUKIHIRO MATSUMOTO, Saitama (JP)

(21) Appl. No.: 19/049,170

(22) Filed: Feb. 10, 2025

(30) Foreign Application Priority Data
Feb. 22, 2024 (JP) 2024-025507

(51) Int. Cl. H04N 25/50; H04N 25/76

(52) U.S. Cl. CPC H04N 25/50; H04N 25/76

(57) ABSTRACT

An image capturing system including an image capturing apparatus and a lighting device, which are communicably connected to each other. The image capturing apparatus includes an image sensor and a system controller configured to control a charge accumulation time in the image sensor. The lighting device includes a light emission section and a video light controller configured to control light emission from the light emission section by performing PWM control. The system controller determines a frequency in the PWM control based on the charge accumulation time and notifies the determined frequency to the video light controller. The video light controller controls light emission from the light emission section at the frequency in the PWM control, which is notified from the system controller.

### BACKGROUND

### Technical Field

The aspect of the embodiments relates to, in an image capturing system including a lighting device and an image capturing apparatus, a technique for controlling light emission from the lighting device.

### Description of the Related Art

In a dark place, shooting is performed using a lighting device that illuminates an object and its background. In doing this, as the lighting device used, a strobe device is used in the case of still image shooting, a video light is used in the case of moving image shooting, and these are used in a state incorporated in an image capturing apparatus (camera), or in a state physically or wirelessly connected to the image capturing apparatus.

Here, as the video light, one using an incandescent light as the light source has been conventionally used, but in recent years, one using a light emitting diode (LED) as the light source has been increasingly used. By using the LED for the light source, it is possible to easily adjust the intensity of light irradiated on an object by changing a voltage to be applied, and further by performing pulse width modulation (PWM) control.

In the PWM control, the amount of light emission is adjusted by repeating on/off of the voltage to be input to the LED to thereby continuously perform lighting/non-lighting of the LED. Therefore, it is known that, in a camera using a CMOS sensor which acquires image signals by using the rolling shutter method, stripe-shaped brightness differences similar to flicker appear in a captured image due to light irradiated from the video light to an object, depending on an image capturing condition.

To solve the problem, as a method of reducing the stripes generated on an object image due to irradiation of light from the video light, application of the conventional countermeasure against flicker is considered. For example, Japanese Laid-Open Patent Publication (Kokai) No. 2020-10317 discloses a technique for detecting flicker based on a plurality of images obtained by driving an image sensor at a predetermined period and setting a charge accumulation time (shutter speed) in the image sensor to a value at which an influence of the detected flicker is reduced. By using this technique, it is considered that, by controlling the charge accumulation time in the image sensor based on a frequency (period) at a time when the video light is caused to emit light according to the PWM control, it is possible to perform live view display in which generation of stripes is suppressed.

However, in the above-mentioned conventional technique, the charge accumulation time in the image sensor is limited to the frequency (period) in the PWM control for causing the video light to emit light, and hence for example, a situation can be caused where it is impossible to perform moving image shooting in a desired charge accumulation time.

### SUMMARY

According to a first aspect of the embodiments, there is provided an image capturing system including an image capturing apparatus and a lighting device, which are communicably connected to each other, wherein the image capturing apparatus includes an image sensor, and at least one memory configured to store instructions, and at least one processor in communication with the at least one memory and configured to execute the instructions to function as: a first control unit configured to control a charge accumulation time in the image sensor, wherein the lighting device includes a light emission section; and at least one memory configured to store instructions, and at least one processor in communication with the at least one memory and configured to execute the instructions to function as: a second control unit configured to control light emission from the light emission section by performing PWM control, wherein the first control unit determines a frequency in the PWM control, based on the charge accumulation time, and notifies the determined frequency to the second control unit, and wherein the second control unit controls light emission from the light emission section at the frequency in the PWM control, which is notified from the first control unit.

According to a second aspect of the embodiments, there is provided an image capturing system including an image capturing apparatus and a lighting device, which are communicably connected to each other, wherein the image capturing apparatus includes an image sensor, and at least one memory configured to store instructions, and at least one processor in communication with the at least one memory and configured to execute the instructions to function as: a first control unit configured to control a charge accumulation time in the image sensor, wherein the lighting device includes a light emission section, and at least one memory configured to store instructions, and at least one processor in communication with the at least one memory and configured to execute the instructions to function as: a second control unit configured to control light emission from the light emission section by performing PWM control, wherein the first control unit notifies the charge accumulation time to the second control unit, and wherein the second control unit determines a frequency in the PWM control, based on the charge accumulation time, and controls light emission from the light emission section.

Further features of the disclosure will become apparent from the following description of exemplary embodiments (with reference to the attached drawings).

### BRIEF DESCRIPTION OF THE DRAWINGS

FIG. 1 is a block diagram showing a schematic configuration of an image capturing system according to an embodiment.

FIG. 2 is a flowchart of a shooting process performed by the image capturing system.

FIGS. 3A and 3B are diagrams useful in explaining a relationship between charge accumulation in an image sensor and readout therefrom, and photometric values.

FIGS. 4A to 4C are maps for determining a flicker environment and a determination table.

FIG. 5 is a flowchart of a lighting control process for a video light.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted. Here, as an image capturing system according to the disclosure, a configuration in which a lens barrel (interchangeable lens) and a lighting device are attached to an image capturing apparatus, such as a digital camera, will be described.

Here, in the following description, the image capturing apparatus refers to a main body part (apparatus body) of the image capturing apparatus equipped with an image sensor. However, it is assumed for convenience that the image capturing apparatus also refers to an image capturing apparatus, such as a compact digital camera or a digital video camera, which is formed by integrating a photographic lens with the apparatus body.

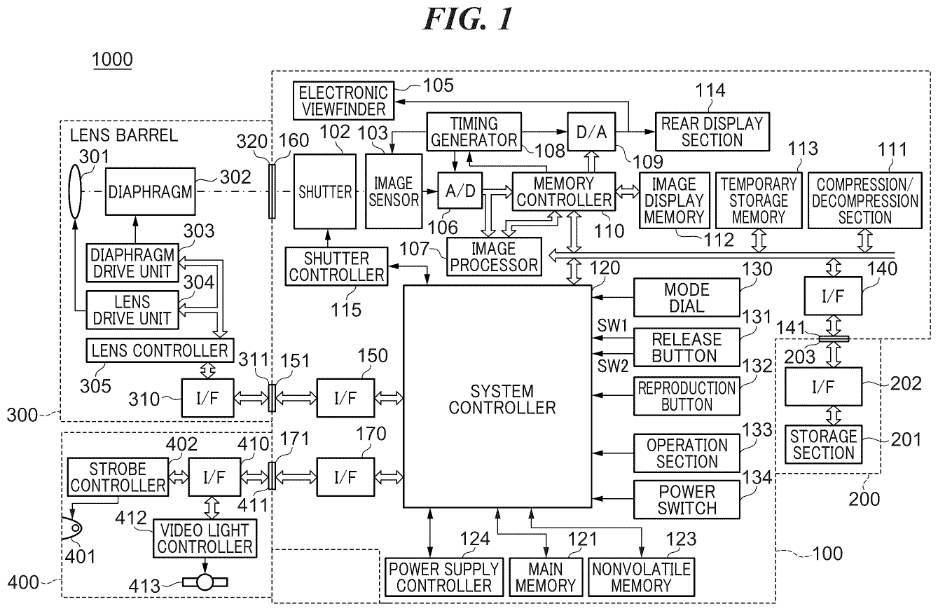

FIG. 1 is a block diagram showing a schematic configuration of an image capturing system 1000 according to an embodiment. The image capturing system 1000 is formed by an image capturing apparatus 100, a lens barrel 300 and a lighting device 400, which are attached to the image capturing apparatus 100, and an external storage medium 200 accommodated in the image capturing apparatus 100.

The image capturing apparatus 100 is, specifically, a digital camera capable of shooting a moving image, and further, here, a mirrorless-type digital single-lens reflex camera is assumed. The image capturing apparatus 100 includes a lens mount 160, an image sensor 103, a shutter 102, a shutter controller 115, an A/D converter 106, an image processor 107, a memory controller 110, a D/A converter 109, an image display memory 112, and a temporary storage memory 113. The image capturing apparatus 100 further includes a compression/decompression section 111, a timing generator 108, an electronic viewfinder 105, a rear display section 114, a system controller 120, a main memory 121, a nonvolatile memory 123, an operation section 133, a mode dial 130, and a release button 131. The image capturing apparatus 100 also includes a reproduction button 132, a power switch 134, a power supply controller 124, a first camera interface (I/F) 140, a second camera I/F 150, a third camera I/F 170, a first camera connector 141, a second camera connector 151, and a third camera connector 171.

The external storage medium 200 includes a media connector 203, a media I/F 202, and a storage section 201.

The lens barrel 300 includes a camera mount 320, a lens connector 311, a lens I/F 310, a photographic lens group 301, a diaphragm 302, a diaphragm drive unit 303, a lens drive unit 304, and a lens controller 305.

The lighting device 400 includes a strobe connector 411, a strobe I/F 410, a strobe controller 402, a strobe light emission section 401, a video light controller 412, and a video light 413.

In the image capturing apparatus 100, the image sensor 103 is a charge accumulation-type photoelectric conversion device, such as a CMOS. An object optical image formed on an imaging surface of the image sensor 103, which has been incident through the lens barrel 300 is converted to analog image signals by photoelectric conversion, and the generated analog signals are output to the A/D converter 106.

The shutter 102 includes a front curtain and a rear curtain as mechanical components, and an actuator which drives the front curtain and the rear curtain, and opens and blocks an optical path between the lens barrel 300 and the image sensor 103 by driving the front curtain and the rear curtain. Note that the shutter 102 is not limited to the mechanical configuration that drives the front curtain and the rear curtain, but can be realized by a function of resetting or reading out image data captured by the image sensor 103 according to electrical control. The shutter controller 115 controls driving of the shutter 102 (the front curtain and the rear curtain) according to a command from the system controller 120.

The A/D converter 106 converts the analog image signals output from the image sensor 103 to digital image data and outputs the generated digital image data to the image processor 107 and the memory controller 110. The image processor 107 performs various kinds of processing operations, such as white balance adjustment processing and gradation processing, on the digital image data sent from the A/D converter 106. The memory controller 110 controls writing and reading of a variety of data acquired from the A/D converter 106, the image processor 107, or the compression/decompression section 111 into and from the image display memory 112 or the temporary storage memory 113.

The image display memory 112 temporarily stores display digital image data of an image to be displayed on the electronic viewfinder 105 and the rear display section 114. The display digital image data written in the image display memory 112 is sent to the D/A converter 109 via the memory controller 110. The D/A converter 109 converts the display digital image data from digital to analog to generate display analog image data and supplies the generated display analog image data to the electronic viewfinder 105 and the rear display section 114.

The temporary storage memory 113 temporarily stores image data output from the image processor 107, image data read out from the external storage medium 200, and the like, and is also used as a work area for the system controller 120. The compression/decompression section 111 loads image data stored in the temporary storage memory 113 and compresses or decompresses the image data by using predetermined image compression method and image decompression method, in a state adapted to a various kinds of uses.

The timing generator 108 generates operation signals (control signals, such as a clock signal) to be supplied to the image sensor 103, the A/D converter 106, the D/A converter 109, and so forth. Further, the timing generator 108 controls accumulation of electric charges in the image sensor 103 by controlling timing of resetting the charges accumulated in the image sensor 103. The electronic viewfinder 105 and the rear display section 114 are each implemented e.g. by a liquid crystal panel or an organic EL panel and display a menu screen and so forth for performing a variety of settings for an object image and the image capturing apparatus 100. The electronic viewfinder 105 employs a configuration that enables a user to confirm displayed contents by bringing an eye into contact with the electronic viewfinder 105, and the rear display section 114 is arranged on a rear surface of the image capturing apparatus 100 via a variangle mechanism and a tilt mechanism.

The system controller 120 controls the overall operation of not only the image capturing apparatus 100, but also the image capturing system 1000. The specific example of processing operations performed by the system controller 120 will be described hereafter, but the processing operations performed by the system controller 120 are not limited to the following example.

The system controller 120 performs photometric calculation using image data acquired by the image sensor 103, calculates a luminance value of an object (obtains luminance information), and determines exposure conditions of the image sensor 103. As the parameters for determining the exposure conditions, an aperture value, a shutter speed, a photographing sensitivity (ISO sensitivity), and so forth are used. Thus, proper exposure for the image sensor 103 is controlled. Further, the system controller 120 performs, based on a result of focus detection on an object, position control of the lens group of the lens barrel 300 to focus on the object.

The system controller 120 controls the charge accumulation time in the image sensor 103 (shutter speed) by particularly controlling the shutter 102 when shooting a still image, and by particularly controlling the image sensor 103 when acquiring a live view image and shooting a moving image. The system controller 120 instructs the strobe controller 402 and the video light controller 412 based on a photometric calculation result, the exposure conditions, and a state of the lighting device 400 to thereby control a light emission amount and light emission timing of the strobe light emission section 401 and the video light 413.

The system controller 120 controls the start and end of moving image recording according to an input signal from the operation section 133 and further can perform shooting using outputs from pixels on the whole imaging surface of the image sensor or shooting using part of the outputs, which are cut out from the pixels, by switching the image capturing range by the image sensor 103. The system controller 120 performs, in still image shooting and moving image shooting, control to display the live view image for confirming an object, on the electronic viewfinder 105 or the rear display section 114. Further, the system controller 120 detects presence/absence and frequency of flicker in a shooting environment by using image data obtained by the image sensor 103.

The other component elements of the image capturing apparatus 100 will be described. The main memory 121 is e.g. a read only memory (ROM) and stores information concerning proper exposure with respect to a luminance value (table data and a program diagram) and data associated with the operations of the image capturing apparatus 100, such as constants for the operations executed by the image capturing apparatus 100, a variety of exposure conditions, and arithmetic expression. The nonvolatile memory 123 is e.g. an Electrically Erasable Programmable Read-Only Memory (EEPROM) and stores a variety of settings of the image capturing system 1000.

The operation section 133 is formed by buttons, switches, a dial, a touch panel, for inputting various kinds of operation instructions to the system controller 120, a sight line detection device, and an audio recognition device, or a combination of these. Note that the operation members included in the operation section 133 are operation members other than the mode dial 130, the release button 131, the reproduction button 132, and the power switch 134, separately illustrated in FIG. 1.

The mode dial 130 is a rotary-type operation member used when a desired shooting mode is set from within a plurality of shooting modes which can be set for the image capturing apparatus 100. In the image capturing apparatus 100, it is possible to set a still image mode for shooting a still image and a moving image mode for recording a moving image. Further, in the shooting modes of still images and moving images, it is possible to set a variety of modes in which the exposure parameters can be automatically or manually set, such as a full-auto mode, a program mode, an aperture priority mode, a shutter speed priority mode, and a manual mode, and necessity/unnecessity of strobe light emission in still image shooting.

The release button 131 is an operation member for instructing the start of a preparation operation and the start of actual shooting in still image shooting and moving image shooting. The release button 131 generates a SW1 signal when a first stroke (half-pressing) thereof is performed, and when the SW1 signal is detected, the system controller 120 starts the shooting preparation operation. In the shooting preparation operation, focus control, exposure control, auto white balance (AWB) processing, and so forth are performed, and when moving image shooting is performed, lighting control and light emission control for the video light 413 of the lighting device 400 are performed as the exposure control, as required. The release button 131 generates a SW2 signal when a second stroke (fully pressing) thereof is performed. When the SW2 signal is detected, the system controller 120 performs a series of processing, ranging from the exposure processing on the image sensor 103 to the processing for storing image data in the external storage medium 200.

The reproduction button 132 is an operation member that instructs to start reproduction processing for reading image data from the temporary storage memory 113 or the external storage medium 200 and displaying the read image data on the rear display section 114. The power switch 134 is an operation member that switches on/off of supply of electric power from a power supply section (not shown), such as a battery, to the components of the image capturing apparatus 100. Note that when the power switch 134 is turned on, electric power can be supplied not only to the image capturing apparatus 100, but also to the lens barrel 300, the external storage medium 200, and the lighting device 400. The power supply controller 124 includes a battery detection circuit, a DC-DC converter, a switch circuit used for switching blocks to be energized, and so forth, and controls supply of electric power from the power supply section to the components of the image capturing apparatus 100.

The first camera I/F 140 is an interface for communicably connecting between the system controller 120 and the external storage medium 200. The second camera I/F 150 is an interface for communicably connecting between the system controller 120 and the lens controller 305. The third camera I/F 170 is an interface for communicably connecting between the system controller 120, and the strobe controller 402 and the video light controller 412. The lens mount 160 is a mount portion on the side of the image capturing apparatus 100, which is engaged with the camera mount 320 of the lens barrel 300 to thereby mechanically connect between the lens barrel 300 and the image capturing apparatus 100.

The first camera connector 141 is connected to the media connector 203 of the external storage medium 200. With this, the image capturing apparatus 100 and the external storage medium 200 are electrically connected to each other, whereby it is made possible to transmit a variety of control signals, image data, and so forth, and further, supply electric power from the image capturing apparatus 100 to the external storage medium 200. The second camera connector 151 is connected to the lens connector 311, and with this, the image capturing apparatus 100 and the lens barrel 300 are electrically connected to each other, whereby it is made possible to transmit a variety of control signals and state signals, data signals, and so forth, and supply electric power from the image capturing apparatus 100 to the lens barrel 300. The third camera connector 171 is connected to the strobe connector 411, and with this, the image capturing apparatus 100 and the lighting device 400 are electrically connected to each other, whereby it is possible to transmit a variety of control signals and state signals, data signals, and so forth, and supply electric power from the image capturing apparatus 100 to the lighting device 400. Note that the second camera connector 151 and the third camera connector 171 can be configured to be capable of executing not only electrical communication, but also optical communication, audio communication, and so forth.

The external storage medium 200 is e.g. a memory card or a hard disk, and the storage section 201 is implemented e.g. by a semiconductor memory or a magnetic disk. The media connector 203 is electrically connected to the first camera connector 141 of the image capturing apparatus 100. The media I/F 202 is an interface for communicably connecting between the external storage medium 200 and the system controller 120.

The lens barrel 300 is an optical device which can be removably attached to the image capturing apparatus 100 and forms an optical image of an object on the image sensor 103. The camera mount 320 is a mount portion on the side of the lens barrel 300, which is engaged with the lens mount 160 of the image capturing apparatus 100 to thereby mechanically connect between the lens barrel 300 and the image capturing apparatus 100. The lens connector 311 is provided inside the camera mount 320 and electrically connects between the lens barrel 300 and the image capturing apparatus 100. The lens connector 311 can be configured to be capable of executing not only electrical communication, but also optical communication, audio communication, and so forth, in accordance with the configuration of the second camera connector 151. The lens I/F 310 is an interface for communicably connecting between the lens controller 305 and the system controller 120.

The lens controller 305 performs centralized control of the components of the lens barrel 300 according to a command from the system controller 120. The photographic lens group 301 is comprised of a plurality of lenses, such as a focus lens, a zoom lens, and an image blur correction lens, and forms an image of incident light on an imaging surface of the image sensor 103. The lens drive unit 304 adjusts the positions of the focus lens and the zoom lens in an optical axis direction according to an instruction from the lens controller 305, and further, drives the image blur correction lens on a plane orthogonal to the optical axis. The diaphragm 302 adjusts the amount of light flux of an object, which is incident through the photographic lens group 301 toward the image sensor 103. Note that the diaphragm 302 and the shutter 102 can be interlockingly controlled. The diaphragm drive unit 303 adjusts an opening amount of the diaphragm 302 according to an instruction from the lens controller 305.

The lighting device 400 can be removably attached to the image capturing apparatus 100, and irradiates an object with flash light according to a photographing environment, or illuminates (performs continuous irradiation of light on) the object. The strobe connector 411 is electrically connected to the third camera connector 171. The strobe connector 411 can be configured to be capable of executing not only electrical communication, but also optical communication, audio communication, and so forth, in accordance with the configuration of the third camera connector 171. The strobe I/F 410 is an interface for communicably connecting between the strobe controller 402 and the video light controller 412, and the system controller 120. The strobe light emission section 401 is e.g. a xenon tube. The strobe controller 402 controls light emission from the strobe light emission section 401 according to a command from the system controller 120.

The video light 413 is implemented e.g. by an LED. The video light controller 412 controls light emission from the video light 413 according to a command from the system controller 120. The light emission control of the video light 413 is performed by the PWM control, and the video light controller 412 notifies a frequency band which can be set in the PWM control to the system controller 120. A variety of settings of the lighting device 400 can be made by an operation performed with respect to an operation section (not shown) included in the lighting device 400 and/or communication from the image capturing apparatus 100.

Note that the processing blocks, such as the system controller 120, the image processor 107, the strobe controller 402, the video light controller 412, and the lens controller 305, can be realized by the hardware, such as an ASIC and a programmable logic array (PLA). This is not limitative, but the processing blocks can be realized by a programmable processor, such as a CPU or MPU, which executes software (combination of the software and the hardware). That is, the same hardware can function as a plurality of functional blocks.

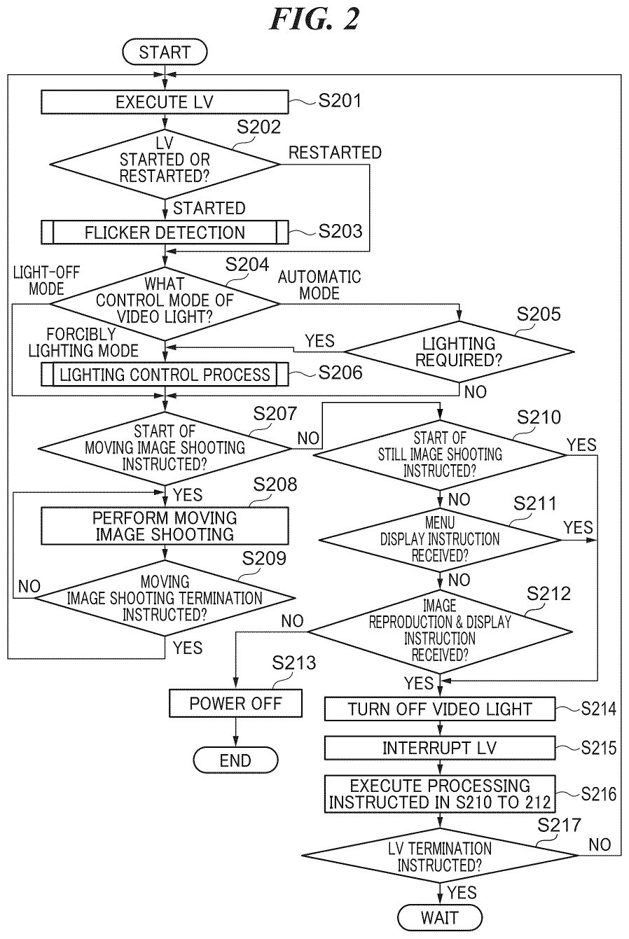

Next, image capturing operations in the image capturing system 1000 will be described. FIG. 2 is a flowchart of a shooting process performed by the image capturing system 1000. Processing operations (steps) each denoted by S number in the flowchart are realized by the system controller 120 that performs centralized control of the image capturing system 1000 by executing a predetermined program. When a user turns on a power switch, not shown, of the lighting device 400 and the power switch 134 of the image capturing apparatus 100 to start the lighting device 400 and the image capturing apparatus 100, the system controller 120 initializes the image capturing system 1000 and the initialization is completed, the system controller 120 starts the process.

When the initialization of the image capturing system 1000 is completed, in a step S201, the system controller 120 executes the live view (denoted as “LV” in FIG. 2). In the live view, an image of an object is acquired, and the acquired image is displayed on the electronic viewfinder 105 or the rear display section 114.

In a step S202, the system controller 120 determines whether the live view has been started by the operation of turning on the power switch 134, or the live view temporarily interrupted in accordance with execution of predetermined processing has been restarted. Note that as an example of the restart, there are a case where moving image shooting has been terminated in a step S209 and a case where predetermined processing, such as still image shooting, has been terminated in a step S216. If it is determined that the live view has been started, the system controller 120 executes a step S203, whereas if it is determined that the live view has been restarted, the system controller 120 executes a step S204.

In the step S203, the system controller 120 performs a flicker detection process. Details of the flicker detection process will be described hereinafter.

In the step S204, the system controller 120 determines a control mode of the video light 413 in the lighting device 400 and branches the process according to a result of the determination. The control mode of the video light 413 refers to a light emission mode of an auxiliary light for shooting, and the auxiliary light for shooting is irradiated on an object by lighting the video light 413. In this step, whether the control mode is set to an automatic mode for automatically determining lighting-on/off of the video light 413, a forcibly lighting mode for forcibly lighting the video light 413, or a light-off mode for inhibiting lighting of the video light 413 is determined. The system controller 120 executes a step S205 if it is determined that the control mode is set to the automatic mode, executes a lighting control process in a step S206 if it is determined that the control mode is set to the forcibly lighting mode, and executes a step S207 if it is determined that the control mode is set to the light-off mode.

In the step S205, the system controller 120 calculates a luminance value of the object from the image (frames) of the live view and determines whether or not it is necessary to turn on the video light 413. In a case where the obtained luminance value is equal to or lower than a predetermined threshold value, the system controller 120 determines that it is necessary to turn on the video light 413 so as to irradiate the object with the auxiliary light for shooting. If it is determined that it is necessary to turn on the video light 413 (YES in S205), the system controller 120 executes the lighting control process in the step S206, whereas if it is determined that it is not necessary to turn on the video light 413 (NO in S205), the system controller 120 executes the step S207.

In the step S206, the system controller 120 instructs the video light controller 412 to turn on the video light 413, and with this, the video light 413 is lighted. Note that details of the lighting control process in the 206 will be described hereinafter.

In the step S207, the system controller 120 determines whether or not an instruction for starting moving image shooting has been received. If it is determined that the moving image shooting start instruction has been received (YES in S207), the system controller 120 executes a step S208, whereas if it is determined that an instruction other than the moving image shooting start instruction has been received (NO in S207), the system controller 120 executes a step S210.

In the step S208, the system controller 120 performs moving image shooting (moving image recording).

In the step S209, the system controller 120 determines whether or not a moving image shooting termination instruction has been received. If it is determined that a moving image shooting termination instruction has not been received (NO in S209), the system controller 120 continues the processing in the step S208. If it is determined that a moving image shooting termination instruction has been received (YES in S209), the system controller 120 executes the step S201, and with this, the live view is restarted.

Description of the steps S210 to S212 is given assuming that three instructions other than the moving image shooting start instruction are exemplified, and further, an instruction other than these three instructions is a termination instruction provided by turning off the power switch 134 of the image capturing apparatus 100.

In the step S210, the system controller 120 determines whether or not an instruction for starting still image shooting has been received. If it is determined that a still image shooting start instruction has been received (YES in S210), the system controller 120 executes a step S214, whereas if it is determined that an instruction other than the still image shooting start instruction has been received (NO in S210), the system controller 120 executes the step S211.

In the step S211, the system controller 120 determines whether or not an instruction for displaying a menu has been received. If it is determined that a menu display instruction has been received (YES in S211), the system controller 120 executes the step S214, whereas if it is determined that an instruction other than the menu display instruction has been received (NO in S211), the system controller 120 executes the step S212.

In the step S212, the system controller 120 determines whether or not an image reproduction display instruction has been received. The image to be reproduced may be a still image or a moving image. If it is determined that an image reproduction display instruction has received (YES in S212), the system controller 120 executes the step S214, whereas if it is determined that an instruction other than the image reproduction display instruction has been received (NO in S212), the system controller 120 executes a step S213.

In the step S213, the system controller 120 receives an instruction for turning off the power switch 134 and stops all functions of the image capturing system 1000, followed by terminating the present process.

In the step S214, if the video light 413 is lighting, the system controller 120 turns off the video light 413.

In a step S215, the system controller 120 interrupts the live view.

In the step S216, the system controller 120 executes predetermined processing according to the instruction received in the step S210 to S212.

In a step S217, the system controller 120 determines whether or not a live view termination instruction has been received. If it is determined that a live view termination instruction has received (YES in S217), the system controller 120 waits until the next instruction is received. If it is determined that a live view termination instruction has not received (NO in S217), the system controller 120 executes the step S201, and with this, the live view is restarted.

Note that in the shooting process in FIG. 2, in a case where it is determined in the step S202 that the live view has been restarted, the flicker detection process in the step S203 is not performed. This is not limitative, but the flicker detection process in the step S203 can be performed regardless of whether or not the live view has been started or restarted without performing the determination processing in the step S202. In this case, in a case where the video light 413 has been turned on in the step S206, the video light 413 is turned off before execution of the flicker detection process.

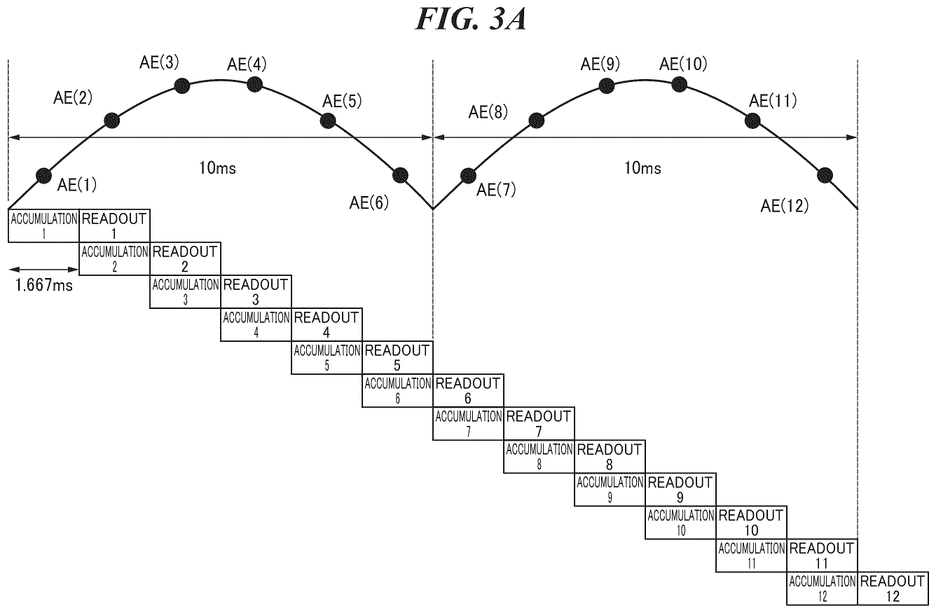

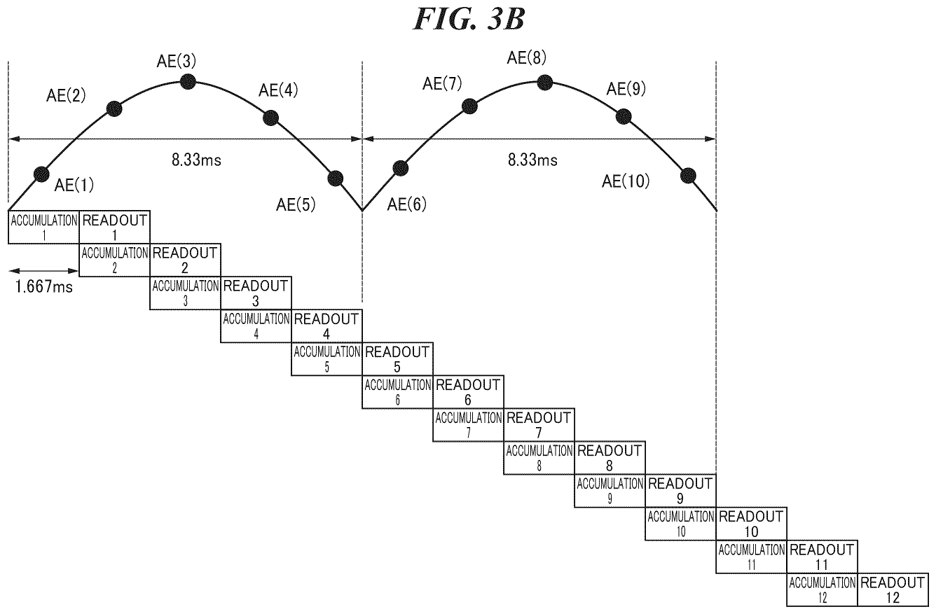

Next, the flicker detection process in the step S203 will be described. FIGS. 3A and 3B are diagrams useful in explaining a relationship between charge accumulation in the image sensor 103 and readout therefrom, and photometric values.

FIG. 3A is a diagram showing charge accumulation control in the image sensor 103 with respect to flicker (having a frequency of 100 Hz) under a light which is lighted by a commercial power source of 50 Hz and changes in the photometric value. Note that flicker detection described hereafter is also used, as illustrated e.g. in FIG. 3B, in a scene wherein a digital signage or the like subjected to lighting control at a predetermined frequency is present within a photographing angle of view, for detecting the lighting frequency of the digital signage.

To detect flicker, the image sensor 103 continuously performs charge accumulation and readout at a frame rate of 600 fps (=period of approximately 1.667 msec). Here, assuming that “n” is a natural number, charge accumulation at the n-th time is expressed as “accumulation n”, readout of the accumulation n is expressed as “readout n”, and a photometric value obtained from a result of the readout n is expressed as “AE (n)”.

In FIG. 3A, the charge accumulation operation is performed 12 times with the same exposure conditions, whereby the photometric values AE (1) to AE (12) are obtained. Note that charge accumulation in the image sensor 103 is performed within a limited time period, and hence the photometric values AE (1) to AE (12) are each represented by a median. An evaluation value SAD (m) used for flicker frequency determination is calculated from the photometric values AE (1) to AE (12) by using the following equation (1):

SAD(m)=Σᵢ₌₁⁶|AE(n)−AE(n+m)| (1)

The evaluation value SAD (m) is one of indexes expressing similarity and is widely used e.g. in a pattern matching field. The value “m” is a value indicating what number-th photometric operation is performed ahead of a photometric operation performed for the photometric value AE (n) at the n-th time in the 12 photometric operations, to determine a photometric value of which similarity with the photometric value AE (n) is calculated. In FIG. 3A, the evaluation value SAD (m) indicates the similarity with the photometric value obtained after the lapse of 1.667×m msec, and as the similarity is higher, the value of SAD (m) is smaller.

For example, in a case where the flicker period under a flicker environment, in which the frequency of the flicker is 100 Hz, is approximately 10 msec, and the charge accumulation time in the image sensor 103 is 1.667 msec, the relationship between these is expressed by 10/1.667≈6. This indicates that, as shown in FIG. 3A, the same photometric value is obtained at every six periods regardless of the accumulation timing in the image sensor 103. That is, as for the photometric value, a relationship expressed by AE (n)≈AE (n+6) holds. From this property, under the flicker environment in which the frequency of the flicker is 100 Hz, SAD (6)≈0 is determined.

To detect presence of flicker having a frequency of 100 Hz, SAD (3) indicating the similarity with a photometric value obtained after the lapse of 1.667×3=5 msec is further calculated. Under the flicker environment in which the frequency of the flicker is 100 Hz, a photometric value obtained at a timing shifted by 5 msec shows an opposite phase relation, and hence the value of SAD (3) is larger than the value of SAD (6). Therefore, in a case where SAD (3) is large, and SAD (6) is small, it is possible to determine that flicker having a frequency of 100 Hz is present.

Similarly, to detect flicker under a light which is lighted by a commercial power source of 60 Hz (the frequency of flicker is 120 Hz), SAD (5) and SAD (3) are only required to be calculated. FIG. 3B is a diagram showing charge accumulation control in the image sensor 103 with respect to flicker under the light which is lighted by the commercial power source of 60 Hz and changes in the photometric value. The period of flicker having a frequency of 120 Hz is 8.333 msec, and hence AE (n)≈AE (n+5) holds, so that SAD (5)≈0 is determined.

Further, the flicker having a frequency of 120 Hz shows the opposite phase relation after the lapse of 4.16 msec, and hence it is preferable to determine the similarity with a photometric value obtained after the lapse of 4.16 msec. However, 4.16 msec is not a natural number multiple (integer multiple except 0 times) of the charge accumulation time of 1.667 msec. Then, as an example of a value relatively close to 4.16 msec, SAD (3) indicating the similarity with a photometric value obtained after the lapse of 5 msec is used. Also under the flicker environment in which the frequency of flicker is 120 Hz, SAD (3) indicates a photometric value close to an opposite-phase relation, and hence SAD (3) indicates a large value with respect to SAD (5).

As described above, in the flicker detection process, SAD (6), SAD (5), and SAD (3) are calculated, and presence/absence of flicker and the frequency in a case where flicker is present are detected based on the relationship between these values.

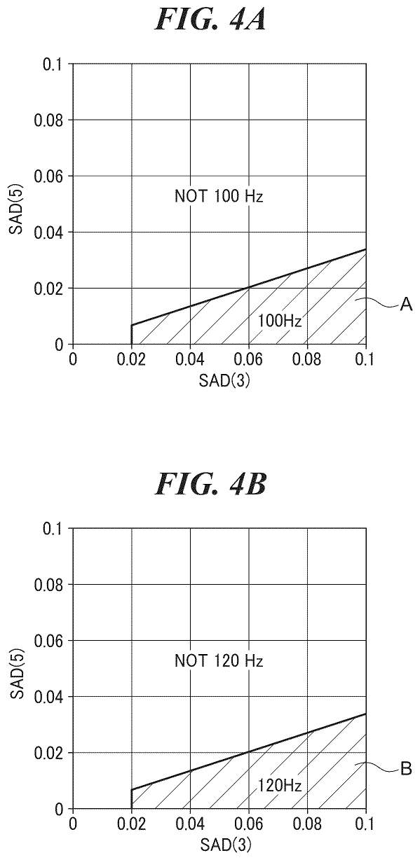

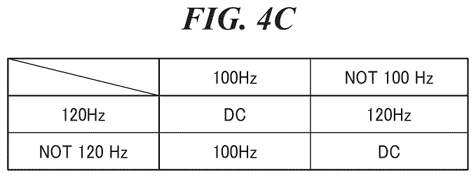

FIG. 4A is a diagram showing an example of a map for determining whether or not flicker having a frequency of 100 Hz is detected. In a coordinate system having SAD (3) set to a horizontal axis and SAD (6) set to a vertical axis, respectively, a lower right area in which SAD (3) takes a large value relative to SAD (6) is set to an area A in which the frequency of flicker is determined as 100 Hz. It is possible to determine whether or not flicker having a frequency of 100 Hz is detected, based on whether or not a plot of SAD (3) and SAD (6), which are actually obtained, is included in the area A.

FIG. 4B is a diagram showing an example of a map for determining whether or not flicker having a frequency of 120 Hz is detected. In a coordinate system having SAD (3) set to a horizontal axis and SAD (5) set to a vertical axis, respectively, a lower right area in which SAD (3) takes a large value relative to SAD (5) is set to an area B in which the frequency of flicker is determined as 100 Hz. It is possible to determine whether or not flicker having a frequency of 120 Hz is detected, based on whether or not a plot of SAD (3) and SAD (5), which are actually obtained, is included in the area B.

Note that a boundary line separating the area A and the other area is illustrated by way of example, and a bending point and inclination of the boundary line are not limited to those illustrated in FIG. 4A, and the same is applied to FIG. 4B.

FIG. 4C is a table for finally determining presence/absence and the frequency of flicker, based on a result of the detection, obtained from FIGS. 4A and 4B. In a case where it is determined that the frequency of flicker is 100 Hz and at the same time is not 120 Hz, the frequency of flicker is finally determined as 100 Hz. Similarly, in a case where it is determined that the frequency of flicker is not 100 Hz and at the same time is 120 Hz, the frequency of flicker is finally determined as 120 Hz.

In a case where flicker is absent and stationary light (DC) is measured, the photometric value does not temporally change, and hence a relationship expressed by AE (1)≈AE (2)≈AE (3)≈ . . . ≈AE (12) is obtained. As a result, SAD (6)≈SAD (5)≈SAD (3)≈0 is obtained. Therefore, the photometric value of the stationary light is plotted in the vicinity of the origin in the respective coordinate systems shown in FIGS. 4A and 4B, and it is determined that the frequency of flicker is neither 100 Hz nor 120 Hz. As a result, in a case where it is determined that the frequency of flicker is neither 100 Hz nor 120 Hz, it is determined that the light source is the stationary light.

In general, it is normally difficult to consider that the flicker is determined to have a frequency of 100 Hz and also have a frequency of 120 Hz, but this determination result is sometimes obtained, for example, in a case where the photometric values AE (1) to AE (12) are acquired e.g. from a moving object or different objects due to a panning operation. In such a case, by regarding that an error has occurred, it is determined that the light source is the stationary light. With the above-described process, it is possible to determine presence/absence of flicker and whether the frequency in a case where flicker is present is 100 Hz or 120 Hz.

Next, the lighting control process for the video light 413 in the step S206 will be described. Conventionally, exchange of the following information and data is performed between an image capturing apparatus and a lighting device. Specifically, from the image capturing apparatus to the lighting device, information on a charge accumulation time in the image sensor, an aperture value, an ISO sensitivity, a shooting mode, a lens focal distance, a light emission time in the lighting device, and an instruction for turning on/off the lighting device, is transmitted. Further, from the lighting device to the image capturing apparatus, information on a light emission mode, a guide number, and color temperature is transmitted.

In addition to these items of information, in the present embodiment, the image capturing apparatus 100 transmits an instruction of the frequency and the duty ratio (light emission amount) of the PWM control at a time when the video light 413 is lighted to the lighting device 400. On the other hand, the lighting device 400 transmits the lighting state (the frequency and the duty ratio in the PWM control) of the video light 413 to the image capturing apparatus 100.

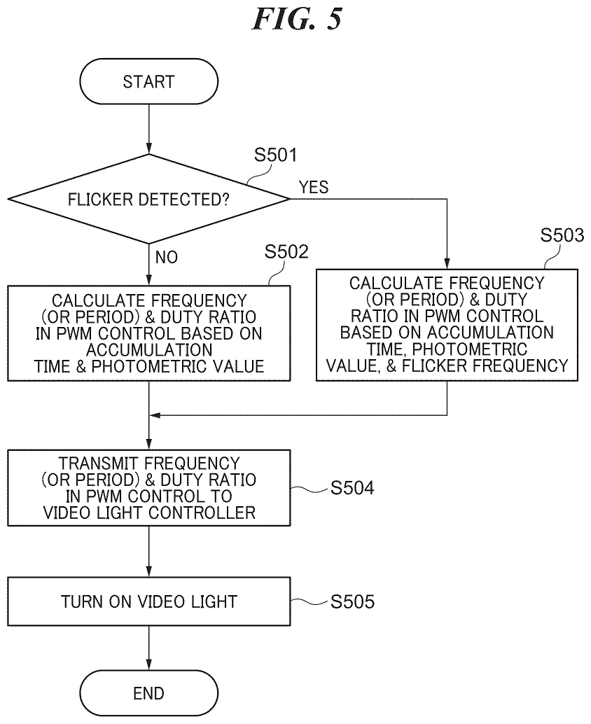

FIG. 5 is a flowchart of the lighting control process for the video light 413, which is performed in the step S206. In a step S501, the system controller 120 determines whether or not flicker has been detected in the step S203. If it is determined that flicker has not been detected (NO in S501), the system controller 120 executes a step S502, whereas if it is determined that flicker has been detected (YES in S501), the system controller 120 executes a step S503.

In the step S502, the system controller 120 calculates a frequency (or period) and a duty ratio in the PWM control for lighting the video light 413, based on the charge accumulation time in the image sensor 103 at a time when the live view is executed and the luminance value of the object. Details of a method of determining the frequency (or period) and the duty ratio in the PWM control in the step S502 will be described hereinafter.

In the step S503, the system controller 120 calculates a frequency (or period) and a duty ratio in the PWM control for lighting the video light 413, based on the charge accumulation time in the image sensor 103 at a time when the live view is executed, the luminance value of the object, and the frequency of flicker detected in the step S203. Details of a method of determining the frequency (or period) and the duty ratio in the PWM control in the step S503 will be described hereinafter.

When the processing in the step S502 or S503 is terminated, the system controller 120 executes a step S504. In the step S504, the system controller 120 transmits a result of the calculation in the step S502 or S503 (the frequency and the duty ratio in the PWM control for lighting the video light 413) to the video light controller 412.

In a step S505, the video light controller 412 lights the video light 413 by performing the PWM control at the frequency (period) and the duty ratio, which have been received from the system controller 120. Note that the video light controller 412 notifies the lighting state of the video light 413 (the actual frequency and duty ratio in the PWM control) to the system controller 120 at fixed time intervals. This terminates the lighting control process for the video light 413 is terminated.

Next, the details of the methods used when determining the frequency and the duty ratio in the PWM control in the steps S502 and S503 will be described. Assuming that the frequency of the PWM control for the video light 413 is represented by “F”, the charge accumulation time in the image sensor 103 is represented by “t”, and the natural number is represented by “N”, the frequency F of the PWM control in a case where flicker has not been detected is determined by F=1/(t×N). Further, the duty ratio for determining the light emission amount of the video light 413 is determined by using a known technique such that proper exposure is obtained with respect to the luminance value of the object. With this, it is possible to perform moving image shooting and live view, in which stripes generated due to lighting of the video light 413 are suppressed.

In a case where flicker has been detected in the step S203, in the present embodiment, the priority is given to adjusting the frequency of the PWM control for the video light 413 to the frequency of the detected flicker.

For example, if the frequency of the detected flicker is 100 Hz, the system controller 120 sets the frequency F of the PWM control for the video light 413 to 100 Hz. Then, the system controller 120 sets the charge accumulation time in the image sensor 103 to a natural number multiple of 1/100 second which is a period corresponding to the frequency of 100 Hz to suppress generation of stripes in a photographed image. Note that this method of suppressing generation of stripes is known (see e.g. Japanese Laid-Open Patent Publication (Kokai) No. 2009-213076), and hence detailed description thereof is omitted. The duty ratio for determining the light emission amount of the video light 413 is determined such that proper exposure is obtained with respect to the luminance value of the object, similarly to the case where flicker has not been detected.

However, in the case where flicker has been detected in the step S203, if it is impossible to adjust the frequency of the PWM control to the frequency of the detected flicker, the frequency of the PWM control is set similarly to the case where flicker has not been detected.

Note that in the case where flicker has been detected in the step S203, if the image capturing apparatus 100 is in a mode in which the shutter speed is not fixed, such as the aperture priority mode, it is possible to cope with the frequency adjustment as described above. On the other hand, in a case where the charge accumulation time in the image sensor 103 is fixed to a value which is not a natural number multiple of the period of flicker, the system controller 120 outputs a warning. The warning is provided e.g. by displaying the warning on the rear display section 114 or the electronic viewfinder 105, outputting a warning sound in a case where a speaker is equipped, or displaying, in a case where the lighting device 400 includes a display section, the warning on this display section.

Further, the system controller 120 is required to determine the frequency F within a range of the frequency band notified from the video light controller 412, which can be set in the PWM control. In a case where the video light controller 412 does not support the PWM control at the frequency F calculated based on the charge accumulation time calculated based on the fixed aperture value or the charge accumulation time fixed in advance, the system controller 120 outputs a warning. For example, as such a case, there can be mentioned a case where the video light controller 412 does not have the capability of generating a pulse wave of the frequency F. Note that the warning can be provided by using the above-mentioned methods.

In the above-described embodiment, the system controller 120 calculates the frequency F and the duty ratio in the PWM control for lighting the video light 413. This is not limitative, but the video light controller 412 can calculate and determine the frequency F (or period) and the duty ratio in the PWM control for lighting the video light 413. In this configuration, the system controller 120 transmits the charge accumulation time in the image sensor 103, the luminance value of the object, a result of the flicker detection in the step S203 (the information on presence/absence of flicker and the frequency of flicker if detected) to the video light controller 412.

In a case where the video light controller 412 determines the frequency F, the video light controller 412 is not required to notify the frequency band which can be set in the PWM control to the system controller 120 but determines the frequency F within this frequency band. Then, the video light controller 412 transmits the set frequency F and information indicating whether or not the frequency F can be synchronized with the charge accumulation time in the image sensor 103 to the system controller 120. In a case where the frequency F calculated based on the charge accumulation time in the image sensor 103 is outside the frequency band which can be set, the video light controller 412 further notifies a warning to the system controller 120. The system controller 120 having received this warning can be configured to output a warning. Note that as the method of providing the warning, the above-described methods can be used.

The disclosure has been described heretofore based on the preferred embodiment thereof. However, the disclosure is not limited to the specific embodiment, but it is to be understood that the disclosure includes various forms within the scope of the gist of the disclosure. Further, the embodiment of the disclosure is described only by way of example, and it is possible to combine elements of the embodiment on an as-needed basis.

For example, although in the above-described embodiment, the configuration in which the lens barrel 300 and the lighting device 400 can be removably attached to the image capturing apparatus 100 has been described, the lens barrel 300 and the lighting device 400 can be integrally formed with the image capturing apparatus 100. In this case, the system controller 120 also functions as the lens controller 305, the strobe controller 402, and the video light controller 412. Further, although the configuration in which the lighting device 400 is physically connected to the image capturing apparatus 100 via the connector has been described, the lighting device 400 and the image capturing apparatus 100 can be controllably connected by wireless communication. Further, although as the image capturing apparatus 100 as a component of the image capturing system according to the disclosure, the mirrorless-type digital camera has been described, the image capturing apparatus 100 is not limited to this but can be a portable device, such as a digital video camera or a smartphone.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-025507 filed Feb. 22, 2024, which is hereby incorporated by reference herein in its entirety.

What is claimed is:

1. An image capturing system including an image capturing apparatus and a lighting device, which are communicably connected to each other,
wherein the image capturing apparatus comprises:
an image sensor; and
at least one memory configured to store instructions, and at least one processor in communication with the at least one memory and configured to execute the instructions to function as:
a first control unit configured to control a charge accumulation time in the image sensor,
wherein the lighting device comprises:
a light emission section; and
at least one memory configured to store instructions, and at least one processor in communication with the at least one memory and configured to execute the instructions to function as:
a second control unit configured to control light emission from the light emission section by performing PWM control,
wherein the first control unit determines a frequency in the PWM control, based on the charge accumulation time, and notifies the determined frequency to the second control unit, and
wherein the second control unit controls light emission from the light emission section at the frequency in the PWM control, which is notified from the first control unit.

2. The image capturing system according to claim 1, wherein assuming that the frequency in the PWM control is represented by “F”, the charge accumulation time is represented by “t”, and a natural number is represented by “N”, the frequency in the PWM control is determined by calculating F=1/(t×N).

3. The image capturing system according to claim 2, wherein the instructions are executed to further function as a detection unit configured to detect flicker, and
wherein in a case where flicker is not detected by the detection unit, the frequency in the PWM control is determined by calculating F=1/(t×N), whereas in a case where flicker is detected by the detection unit, the frequency in the PWM control is determined to be the same frequency as a frequency of the detected flicker.

4. The image capturing system according to claim 3, wherein in a case where flicker is detected by the detection unit, the charge accumulation time is set to a natural number multiple of a period of the detected flicker.

5. The image capturing system according to claim 3, wherein in a case where flicker is detected by the detection unit, when it is impossible to set the frequency in the PWM control to the same frequency as the frequency of the detected flicker, the frequency in the PWM control is determined by calculating F=1/(t×N).

6. The image capturing system according to claim 1, wherein the instructions are executed to further function as:
a detection unit configured to detect luminance information from an image acquired by the image sensor, and
a setting unit configured to set a duty ratio in the PWM control, based on the detected luminance information.

7. The image capturing system according to claim 1, wherein the instructions are executed to further function as a warning unit configured to output a warning in a case where the second control unit does not support the frequency in the PWM control, which is determined based on the charge accumulation time.

8. An image capturing system including an image capturing apparatus and a lighting device, which are communicably connected to each other,
wherein the image capturing apparatus comprises:
an image sensor; and
at least one memory configured to store instructions, and at least one processor in communication with the at least one memory and configured to execute the instructions to function as:
a first control unit configured to control a charge accumulation time in the image sensor,
wherein the lighting device comprises:
a light emission section; and
at least one memory configured to store instructions, and at least one processor in communication with the at least one memory and configured to execute the instructions to function as:
a second control unit configured to control light emission from the light emission section by performing PWM control,
wherein the first control unit notifies the charge accumulation time to the second control unit, and
wherein the second control unit determines a frequency in the PWM control, based on the charge accumulation time, and controls light emission from the light emission section.

9. The image capturing system according to claim 8, wherein assuming that the frequency in the PWM control is represented by “F”, the charge accumulation time is represented by “t”, and a natural number is represented by “N”, the frequency in the PWM control is determined by calculating F=1/(t×N).

10. The image capturing system according to claim 9, wherein the instructions are executed to further function as a detection unit configured to detect flicker, and
wherein in a case where flicker is not detected by the detection unit, the frequency in the PWM control is determined by calculating F=1/(t×N), whereas in a case where flicker is detected by the detection unit, the frequency in the PWM control is determined to be the same frequency as a frequency of the detected flicker.

11. The image capturing system according to claim 10, wherein in a case where flicker is detected by the detection unit, the charge accumulation time is set to a natural number multiple of a period of the flicker.

12. The image capturing system according to claim 10, wherein in a case where flicker is detected by the detection unit, when it is impossible to set the frequency in the PWM control to the same frequency as a frequency of the detected flicker, the frequency in the PWM control is determined by calculating F=1/(t×N).

13. The image capturing system according to claim 8, wherein the instructions are executed to further function as:
a detection unit configured to detect luminance information from an image acquired by the image sensor, and
a setting unit configured to set a duty ratio in the PWM control based on the luminance information.

14. The image capturing system according to claim 8, wherein the instructions are executed to further function as a warning unit configured to output a warning in a case where the second control unit does not support the frequency in the PWM control, which is determined based on the charge accumulation time.

15. An image capturing apparatus comprising:
an image sensor;
at least one memory configured to store instructions, and at least one processor in communication with the at least one memory and configured to execute the instructions to function as:
a communication unit configured to perform communication with a lighting device;
a determination unit configured to determine, assuming that the charge accumulation time in the image sensor is represented by “t”, a natural number is represented by “N”, and the frequency in the PWM control at a time when the lighting device controls light emission by performing the PWM control is represented by “F”, the frequency in the PWM control by calculating F=1/(t×N), and
a notification unit configured to notify the frequency determined by the determination unit by using the communication unit to the lighting device.

16. An image capturing apparatus comprising:
an image sensor;
a light emission section configured to emit light toward an object; and
at least one memory configured to store instructions, and at least one processor in communication with the at least one memory and configured to execute the instructions to function as:
a control unit configured to control light emission from the light emission section by performing PWM control and control a charge accumulation time in the image sensor,
wherein assuming that the charge accumulation time is represented by “t”, a natural number is represented by “N”, and the frequency in the PWM control is represented by “F”, the control unit determines the frequency in the PWM control by calculating F=1/(t×N).

17. A lighting device comprising:
a light emission section; and
at least one memory configured to store instructions; and at least one processor in communication with the at least one memory and configured to execute the instructions to function as:
a control unit configured to control the light emission section by performing PWM control;
a communication unit configured to perform communication with an image capturing apparatus; and
an acquisition unit configured to acquire a charge accumulation time set to an image sensor included in the image capturing apparatus, by using the communication unit,
wherein assuming that the charge accumulation time is represented by “t”, a natural number is represented by “N”, and the frequency in the PWM control is represented by “F”, the control unit determines the frequency in the PWM control by calculating F=1/(t×N).

18. A method of controlling an image capturing system in which an image capturing apparatus and a lighting device are communicably connected to each other, comprising:
setting a charge accumulation time in an image sensor of the image capturing apparatus; and
determining, assuming that the charge accumulation time is represented by “t”, a natural number is represented by “N”, and a frequency in PWM control for causing a light emission section included in the lighting device to emit light is represented by “F”, the frequency in the PWM control by calculating F=1/(t×N).

19. The method according to claim 18, further comprising detecting flicker, and
wherein in a case where flicker is not detected, the frequency in the PWM control is determined by calculating F=1/(t×N), whereas in a case where flicker is detected, the frequency in the PWM control is determined to be the same frequency as a frequency of the flicker.

20. A non-transitory computer-readable storage medium storing a program for causing a computer to execute a method of controlling an image capturing system in which an image capturing apparatus and a lighting device are communicably connected to each other,
wherein the method comprises:
setting a charge accumulation time in an image sensor of the image capturing apparatus; and
determining, assuming that the charge accumulation time is represented by “t”, a natural number is represented by “N”, and a frequency in PWM control for causing a light emission section included in the lighting device to emit light is represented by “F”, the frequency in the PWM control by calculating F=1/(t×N).
